(19) United States
(12) Patent Application Publication
(10) Pub. No.: US 2008/0254761 A1
(43) Pub. Date: Oct. 16, 2008

(54) Radio frequency (RF) module

(75) Inventors: Hans Alfred Troemel, Peachtree City, GA (US); Jason Quentin Paulsel, Peachtree City, GA (US)

Correspondence Address: PANASONIC AUTOMOTIVE SYSTEM;COMPANY OF AMERICA, 776 HWY 74 SOUTH, PEACHTREE CITY, GA, 30269, US

(73) Assignee: Panasonic Automotive Systems Company of America, Division of Panasonic Corporation of North America, Peachtree City, GA (US)

(21) Appl. No.: 11/784,909

(22) Filed: Apr. 10, 2007

(51) Int. Cl. H04B 1/06

(52) U.S. Cl. 455/344

(57) ABSTRACT

The disclosed embodiments relate to a radio frequency (RF) receiver module (100). An exemplary embodiment of the RF receiver module (100) comprises a base (102), an RF connector (104) secured to the base (102), the RF connector (104) adapted to receive an RF signal from an audio signal source, and a cable connector (106) secured to the base (102), the cable connector (106) adapted to receive a cable (206) that connects the RF receiver module (100) to an audio system main printed circuit board (206) to transfer an audio signal derived from the RF signal to the audio system main printed circuit board (206).

### FIELD OF THE INVENTION

The present invention generally relates to audio systems. In particular, the present invention relates to a radio frequency (RF) tuner module that is highly configurable for use in a wide range of audio system design applications.

### BACKGROUND OF THE INVENTION

In conventional RF tuner module applications, the RF tuner module is directly mounted to an audio system main printed circuit board (PCB) through a header connector. The mounting of the RF tuner module to the main PCB in this manner necessitates the use of additional components such as mechanical brackets to stabilize the RF tuner module relative to the audio system main PCB. Also, direct mounting of the RF receiver module to the main PCB takes up valuable board space on the main PCB and could require an additional hand insertion step and an additional soldering process step for assembly. These additional steps are undesirable from the standpoints of manufacturing quality and cost.

### SUMMARY OF THE INVENTION

The disclosed embodiments relate to a radio frequency (RF) receiver module. An exemplary embodiment of the RF receiver module comprises a base, an RF connector secured to the base, the RF connector adapted to receive an RF signal from an audio signal source, and a cable connector secured to the base, the cable connector adapted to receive a cable that connects the RF receiver module to an audio system main printed circuit board to transfer an audio signal derived from the RF signal to the audio system main printed circuit board.

### BRIEF DESCRIPTION OF THE DRAWINGS

The above-mentioned and other features and advantages of the present invention, and the manner of attaining them, will become apparent and be better understood by reference to the following description of one embodiment of the invention in conjunction with the accompanying drawings, wherein:

FIG. 1 is a perspective view of an RF receiver module in accordance with an exemplary embodiment of the present invention;

FIG. 2 is a perspective view of an audio system in accordance with an exemplary embodiment of the present invention; and

FIG. 3 is a perspective view of an alternative audio system in accordance with an exemplary embodiment of the present invention.

Corresponding reference characters indicate corresponding parts throughout the several views. The exemplifications set out herein illustrate a preferred embodiment of the invention, in one form, and such exemplifications are not to be construed as limiting in any manner the scope of the invention.

### DETAILED DESCRIPTION OF THE PREFERRED EMBODIMENTS

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Exemplary embodiments of the present invention allow improved flexibility in the design of audio systems. In particular, an RF receiver module in accordance with an exemplary embodiment of the present invention is adapted to support a wide range of physical system configurations because the RF receiver module is not necessarily secured directly to an audio system main PCB. Moreover, an RF receiver module constructed in accordance with an exemplary embodiment of the present invention may be disposed remotely or spaced apart with respect to the system main PCB or attached to the system main PCB in a manner that takes up significantly less space than in conventional audio system designs.

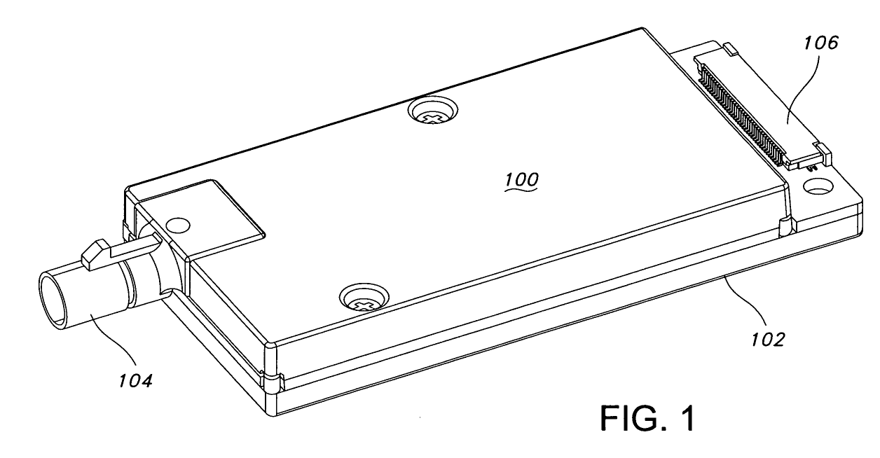

FIG. 1 is a perspective view of an RF receiver module in accordance with an exemplary embodiment of the present invention. The RF receiver module is generally referred to by the reference number 100. The RF receiver module 100 includes a base 102, which serves as a support for various electronic components that receive and decode an RF signal. Exemplary embodiments of the RF receiver module 100 comprise decoders for one or more of the following types of signals: XM satellite radio, Sirius satellite radio, AM/FM radio, Global Positioning System (GPS), WiMAX, Digital Audio Broadcasting (DAB) digital radio, cellular telephone or similar receivers and transceivers. An audio system in accordance with an exemplary embodiment of the present invention includes one or more RF receiver modules, each adapted to receive and decode one or more signal type.

The RF receiver module 100 includes an RF connector 104 and a ribbon cable connector 106. The RF connector 104 is adapted to receive an RF signal from a signal source such as an antenna (not shown). The received RF signal is decoded by circuitry disposed on the base 102 of the RF receiver module 100. An exemplary RF connector 104 is manufactured by Amphenol RF, Four Old Newtown Road, Danbury, Conn. 06810. Such connectors may be designed to comply with industry standards, such as the FAKRA and USCAR standards. The presence of the RF connector 104 on the RF receiver module 100 reduces the need for an RF cable to be connected to the product RF interface. By embedding the main RF interface connector within the module, performance and cost can be optimized. The need for a pig-tail RF cable or main board interface circuitry is eliminated. The module can interface directly to the antenna cable and can reside anywhere within the audio unit. All in all, this method provides ease of implementation in a cost effective manner, while maintaining the performance integrity of the module design.

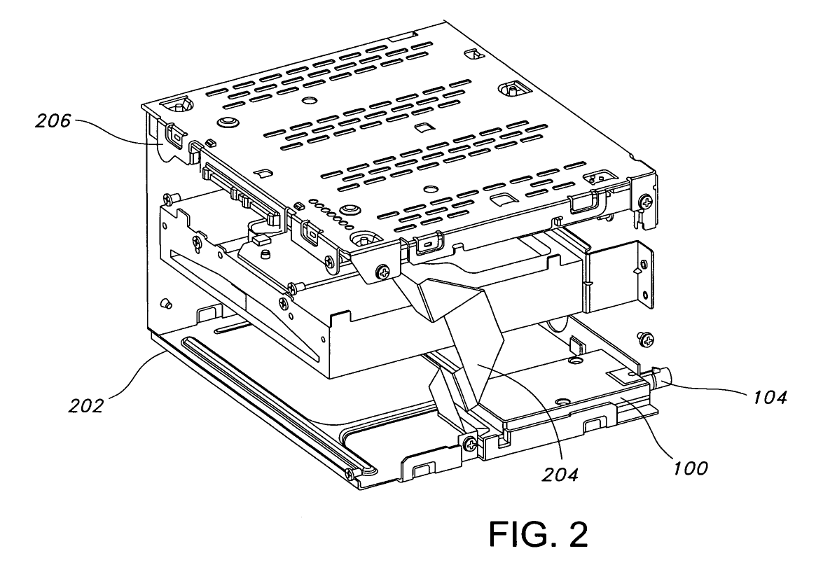

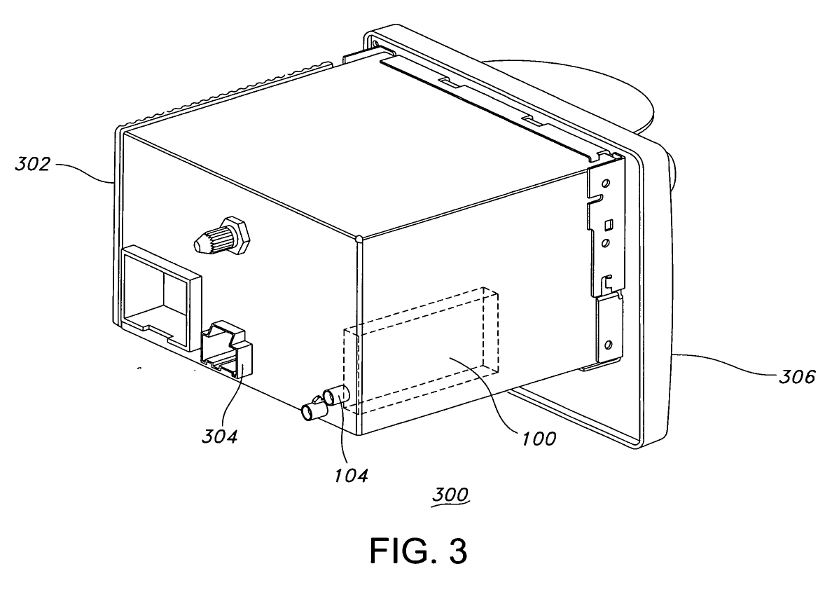

The ribbon cable connector 106 is adapted to accommodate a ribbon cable that connects to an audio system main PCB, which supports general audio processing circuitry. For example, the audio system PCB may include a processor that controls the overall operation of the audio system. Additionally, the audio system main PCB may be adapted to facilitate user selection of system parameters such as signal source, volume or the like. In an exemplary embodiment of the present invention, the ribbon cable connector 106 is adapted to provide a power signal received from an audio system main PCB to the RF receiver module 100. As illustrated below with reference to FIG. 2 and FIG. 3, an exemplary embodiment of the ribbon cable connector 106 is adapted to connect the RF receiver module 100 to an audio system main PCB to transfer an audio signal derived from a received RF signal to the audio system main PCB. As illustrated below with reference to FIG. 2 and FIG. 3, an exemplary embodiment of the ribbon cable connector 106 is adapted to connect the RF receiver module 100 to an audio system main PCB to transfer an audio (and data) signal(s) derived from a received RF signal to the audio system main PCB.

An exemplary embodiment of the RF receiver module 100 is adapted to be loosely joined to the audio system main PCB to allow the RF receiver module 100 to be flexibly positioned anywhere within the product space of a given system design. In an exemplary embodiment of the present invention (such as the exemplary embodiment illustrated in FIG. 2), the ribbon cable connector 106 allows placement of the RF receiver module 100 in a spaced apart relationship relative to the audio system main PCB. In another exemplary embodiment (such as the exemplary embodiment illustrated in FIG. 3), the RF receiver module 100 is adapted to be disposed on an edge and at an approximate right angle to the audio system main PCB.

FIG. 2 is a perspective view of an audio system in accordance with an exemplary embodiment of the present invention. The audio system is generally referred to by the reference number 200. An exemplary embodiment of the audio system 200 comprises a chassis 202, which supports system components such as the RF receiver module 100. In the audio system 200, the RF receiver module 100 is disposed adjacent to the chassis 202. The RF connector 104 is adapted to receive an RF signal from a signal source such as an antenna (not shown). A ribbon cable 204 is connected between the RF receiver module 100 and an audio system main PCB 206. As shown in FIG. 2, the audio system main PCB 206 is spaced apart from the RF receiver module 100 by virtue of its connection via the ribbon cable 204. Moreover, the RF receiver module 100 could be disposed at any desired location within the chassis 202 of the audio system 200 depending on system design criteria.

FIG. 3 is a perspective view of an audio system in accordance with an exemplary embodiment of the present invention. The audio system is generally referred to be the reference number 300. The audio system 300 comprises a chassis 302, which is adapted to secure various components of the system 300. An audio system main PCB 304 is attached to the chassis 302. In the exemplary embodiment illustrated in FIG. 3, the RF receiver module 100 is disposed on an edge and at an approximate right angle relative to the audio system main PCB 304. The connection of the RF receiver module 100 to the audio system main PCB 304 via a ribbon cable (not shown) eliminates additional mounting hardware such as a mounting bracket, while allowing disposal of the RF receive module 100 in a manner that minimizes the use of space on the audio system main PCB 304.

As illustrated in FIG. 3, the RF receiver module 100 is positioned in such a manner that the RF connector 104 extends from the back of the chassis 302. The RF connector 104 may be connected to a source of an RF signal (not shown), as described above. The audio system 300 comprises a faceplate 306, which may provide access to various system controls by a user.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A radio frequency (RF) receiver module (100), comprising:
a base (102);
an RF connector (104) secured to the base (102), the RF connector (104) adapted to receive an RF signal from an audio signal source; and
a cable connector (106) secured to the base (102), the cable connector (106) adapted to receive a cable (206) that connects the RF receiver module (100) to an audio system main printed circuit board (206) to transfer an audio signal derived from the RF signal to the audio system main printed circuit board (206).

2. The RF receiver module (100) recited in claim 1, wherein the cable connector (106) is adapted to receive a ribbon cable (204).

3. The RF receiver module (100) recited in claim 1, wherein the cable connector (106) is adapted to provide a power signal received from the audio system main printed circuit board (206) to the RF receiver module (100).

4. The RF receiver module (100) recited in claim 1, wherein the RF receiver module (100) is adapted to be spaced apart from the audio system main printed circuit board (206) in an audio system (200).

5. The RF receiver module (100) recited in claim 1, wherein the RF receiver module (100) is adapted to be disposed on an edge and at an approximate right angle to the audio system main printed circuit board (304) in an audio system (300).

6. The RF receiver module (100) recited in claim 1, wherein the RF signal comprises an XM satellite radio signal.

7. The RF receiver module (100) recited in claim 1, wherein the RF signal comprises a Sirius satellite radio signal.

8. The RF receiver module (100) recited in claim 1, wherein the RF signal comprises an AM/FM radio signal.

9. The RF receiver module (100) recited in claim 1, wherein the RF signal comprises a Global Positioning System (GPS) signal.

10. The RF receiver module (100) recited in claim 1, wherein the RF signal comprises a Digital Audio Broadcasting (DAB) digital radio signal.

11. The RF receiver module (100) recited in claim 1, wherein the RF signal comprises a cellular telephone signal.

12. An audio system (200), comprising:
an audio system main printed circuit board (PCB) (206); and
a radio frequency (RF) receiver module (100) that includes an RF connector (104) secured to a base (102), the RF connector (104) adapted to receive an RF signal from an audio signal source, and a cable connector (106) secured to the base (102), the cable connector (106) adapted to receive a cable (206) that connects the RF receiver module (100) to the audio system main printed circuit board (206) to transfer an audio signal derived from the RF signal to the audio system main printed circuit board (206), wherein the RF receiver module (100) is adapted to be spaced apart from the audio system main printed circuit board (206).

13. The audio system (200) recited in claim 12, wherein the cable connector (106) is adapted to receive a ribbon cable (204).

14. The audio system (200) recited in claim 12, wherein the cable connector (106) is adapted to provide a power signal received from the audio system main printed circuit board (206) to the RF receiver module (100).

15. The audio system (200) recited in claim 12, wherein the RF signal comprises an XM satellite radio signal.

16. The audio system (200) recited in claim 12, wherein the RF signal comprises a Sirius satellite radio signal.

17. The audio system (200) recited in claim 12, wherein the RF signal comprises an AM/FM radio signal.

18. The audio system (200) recited in claim 12, wherein the RF signal comprises a Global Positioning System (GPS) signal.

19. The audio system (200) recited in claim 12, wherein the RF signal comprises a Digital Audio Broadcasting (DAB) digital radio signal.

20. The audio system (200) recited in claim 12, wherein the RF signal comprises a cellular telephone signal.

21. An audio system (300), comprising:
an audio system main printed circuit board (PCB) (304); and
a radio frequency (RF) receiver module (100) that includes an RF connector (104) secured to a base (102), the RF connector (104) adapted to receive an RF signal from an audio signal source, and a cable connector (106) secured to the base (102), the cable connector (106) adapted to receive a cable (206) that connects the RF receiver module (100) to the audio system main printed circuit board (304) to transfer an audio signal derived from the RF signal to the audio system main printed circuit board (304), wherein the RF receiver module (100) is adapted to be disposed on an edge and at an approximate right angle with respect to the audio system main printed circuit board (304) in an audio system (300).

22. The audio system (300) recited in claim 21, wherein the cable connector (106) is adapted to receive a ribbon cable (204).

23. The audio system (300) recited in claim 21, wherein the cable connector (106) is adapted to provide a power signal received from the audio system main printed circuit board (304) to the RF receiver module (100).

24. The audio system (300) recited in claim 21, wherein the RF signal comprises an XM satellite radio signal.

25. The audio system (300) recited in claim 21, wherein the RF signal comprises a Sirius satellite radio signal.

26. The audio system (300) recited in claim 21, wherein the RF signal comprises an AM/FM radio signal.

27. The audio system (300) recited in claim 21, wherein the RF signal comprises a Global Positioning System (GPS) signal.

28. The audio system (300) recited in claim 21, wherein the RF signal comprises a Digital Audio Broadcasting (DAB) digital radio signal.

29. The audio system (300) recited in claim 21, wherein the RF signal comprises a cellular telephone signal.
